(19) United States
(12) Patent Application Publication
(10) Pub. No.: US 2015/0362626 A1
(43) Pub. Date: Dec. 17, 2015

(54) OPTICAL LENS

(71) Applicant: Panasonic Intellectual Property Management Co., Ltd., Osaka (JP)

(72) Inventor: Makoto UMETANI, Osaka (JP)

(21) Appl. No.: 14/834,969

(22) Filed: Aug. 25, 2015

Related U.S. Application Data
(63) Continuation of application No. PCT/JP2014/000823, filed on Feb. 18, 2014.

(30) Foreign Application Priority Data
Feb. 26, 2013 (JP) 2013-035448

(51) Int. Cl. G02B 1/02

(52) U.S. Cl. CPC G02B 1/02

(57) ABSTRACT

An optical lens is composed of a nanocomposite material that includes a resin material, and nano-fine particles dispersed in the resin material. The nano-fine particles are multiple kinds of nano-fine particles including nano-fine particles formed of at least one selected from SiC, ZnS and Si₃N₄, and nano-fine particles formed of at least one selected from Al₂O₃, ZrO₂, C and AlN. The optical lens has a high refractive index and a high Abbe number, and is usable as a substitute lens for a lens composed of a La glass.

### CROSS-REFERENCE TO RELATED APPLICATION

This application is a Continuation of International Application No. PCT/JP2014/000823, filed on Feb. 18, 2014, which in turn claims the benefit of Japanese Application No. 2013-035448, filed on Feb. 26, 2013, the disclosures of which Applications are incorporated by reference herein.

### BACKGROUND

1. Field

The present disclosure relates to optical lenses.

2. Description of the Related Art

High-precision imaging devices such as digital still cameras (also referred to as “DSC”, hereinafter) adopt optical systems having a plurality of lens units, and various optical materials having different optical constants such as refractive indices, Abbe numbers, partial dispersion ratios are required. Therefore, optical glass materials and optical resin materials having various optical constants have been developed and used. In particular, optical glass materials having a high refractive index and a high Abbe number have been frequently used in many imaging devices to improve optical performances thereof.

On the other hand, technological development has been actively conducted for synthesizing moldable nanocomposite materials having optical constants which could not be achieved by conventional resin materials, by dispersing nano-fine particles having specific optical constants in resin materials. Such nanocomposite materials having optical constants which could not be achieved even by optical glass are expected as substitutions for optical glass having specific optical constants such as a high refractive index and a high Abbe number, or optical glass having poor durability.

Among the nanocomposite materials, a nanocomposite material having a high refractive index has been actively developed. Japanese Laid-Open Patent Publication No. 2006-089706 discloses a material using yttrium oxide (Y₂O₃) as inorganic fine particles, and Japanese Laid-Open Patent Publication No. 2008-203821 discloses a material containing Al, Si, Ti, Zr, Ga, La, or the like.

Optical glass materials having high refractive indices and high Abbe numbers, which influence the performance of high-precision imaging devices such as DSC, belong to mainly a La glass 10 (glass categorized as LaK glass, LaF glass, and LaSF glass in optical glass classification) as shown in a classification map of FIG. 1, and contain a large amount of rare earth elements. Such materials containing a large amount of rare earth elements are very expensive. Since the amount of rare earth elements present on the earth is very small, mass consumption of rare earth elements causes depletion thereof. Therefore, it is an urgent need to develop substitute materials for rare earth elements.

### SUMMARY

The present disclosure provides an optical lens composed of a nanocomposite material that includes no rare earth elements, and has a high refractive index and a high Abbe number. In particular, the present disclosure provides an optical lens composed of a nanocomposite material that allows free control of optical constants in a wide range, and is usable as a substitute material for a La glass.

The novel concepts disclosed herein were achieved in order to solve the foregoing problems in the related art, and herein is disclosed:

an optical lens composed of a nanocomposite material that includes a resin material, and nano-fine particles dispersed in the resin material, wherein the nano-fine particles are multiple kinds of nano-fine particles including nano-fine particles formed of at least one selected from SiC, ZnS and Si₃N₄, and nano-fine particles formed of at least one selected from Al₂O₃, ZrO₂, C and AlN.

The novel concepts disclosed herein were achieved in order to solve the foregoing problems in the related art, and herein is disclosed:

an optical lens composed of a nanocomposite material that includes a resin material, and nano-fine particles dispersed in the resin material, wherein

the nano-fine particles are hybrid nano-fine particles in which at least one selected from Al₂O₃, ZrO₂, C and AlN is added to at least one selected from SiC, ZnS and Si₃N₄.

The novel concepts disclosed herein were achieved in order to solve the foregoing problems in the related art, and herein is disclosed:

an optical lens composed of a nanocomposite material that includes a resin material, and nano-fine particles dispersed in the resin material, wherein

the nano-fine particles are hybrid nano-fine particles in which at least one selected from SiC, ZnS and Si₃N₄ is added to at least one selected from Al₂O₃, ZrO₂, C and AlN.

An optical lens according to the present disclosure, which is composed of a nanocomposite material in which nano-fine particles including at least one selected from SiC, ZnS and Si₃N₄ are dispersed in a resin material, has a high refractive index and a high Abbe number, and is usable as a substitute lens for a lens composed of a La glass such as LaK glass, LaF glass, or LaSF glass in optical glass classification.

### BRIEF DESCRIPTION OF THE DRAWINGS

This and other objects and features of the present disclosure will become clear from the following description, taken in conjunction with the exemplary embodiments with reference to the accompanied drawings in which:

FIG. 1 is a classification map based on the nd-νd relationship of currently existing optical glass materials;

FIG. 2 is a schematic cross-sectional diagram showing a nanocomposite material, and an optical lens composed of the nanocomposite material, according to an embodiment;

FIG. 3 is a graph showing the nd-νd relationship of a nanocomposite material when the content of SiC-C hybrid nano-fine particles is varied, according to the embodiment;

FIG. 4 is a schematic cross-sectional diagram showing a nanocomposite material, and an optical lens composed of the nanocomposite material, according to the embodiment;

FIG. 5 is a graph showing the nd-νd relationship of a nanocomposite material when the volume fractions of SiC nano-fine particles and C nano-fine particles are varied, according to the embodiment;

FIG. 6 is a graph showing the nd-νd relationship of a nanocomposite material when the volume fractions of SiC nano-fine particles and Al₂O₃ nano-fine particles are varied, according to the embodiment;

FIG. 7 is a graph showing the nd-νd relationship of a nanocomposite material when the volume fractions of SiC nano-fine particles and ZrO₂ nano-fine particles are varied, according to the embodiment;

FIG. 8 is a graph showing the nd-νd relationship of a nanocomposite material when the volume fractions of SiC nano-fine particles and AlN nano-fine particles are varied, according to the embodiment;

FIG. 9 is a graph showing the nd-νd relationship of a nanocomposite material when the volume fractions of ZnS nano-fine particles and C nano-fine particles are varied, according to the embodiment;

FIG. 10 is a graph showing the nd-νd relationship of a nanocomposite material when the volume fractions of ZnS nano-fine particles and Al₂O₃ nano-fine particles are varied, according to the embodiment;

FIG. 11 is a graph showing the nd-νd relationship of a nanocomposite material when the volume fractions of ZnS nano-fine particles and ZrO₂ nano-fine particles are varied, according to the embodiment;

FIG. 12 is a graph showing the nd-νd relationship of a nanocomposite material when the volume fractions of ZnS nano-fine particles and AlN nano-fine particles are varied, according to the embodiment;

FIG. 13 is a graph showing the nd-νd relationship of a nanocomposite material when the volume fractions of Si₃N₄ nano-fine particles and C nano-fine particles are varied, according to the embodiment;

FIG. 14 is a graph showing the nd-νd relationship of a nanocomposite material when the volume fractions of Si₃N₄ nano-fine particles and Al₂O₃ nano-fine particles are varied, according to the embodiment;

FIG. 15 is a graph showing the nd-νd relationship of a nanocomposite material when the volume fractions of Si₃N₄ nano-fine particles and ZrO₂ nano-fine particles are varied, according to the embodiment; and

FIG. 16 is a graph showing the nd-νd relationship of a nanocomposite material when the volume fractions of Si₃N₄ nano-fine particles and AlN nano-fine particles are varied, according to the embodiment.

### DETAILED DESCRIPTION

Hereinafter, embodiments will be described with reference to the drawings as appropriate. However, descriptions more detailed than necessary may be omitted. For example, detailed description of already well known matters or description of substantially identical configurations may be omitted. This is intended to avoid redundancy in the description below, and to facilitate understanding of those skilled in the art.

It should be noted that the applicant provides the attached drawings and the following description so that those skilled in the art can fully understand this disclosure. Therefore, the drawings and description are not intended to limit the subject defined by the claims.

### Embodiment

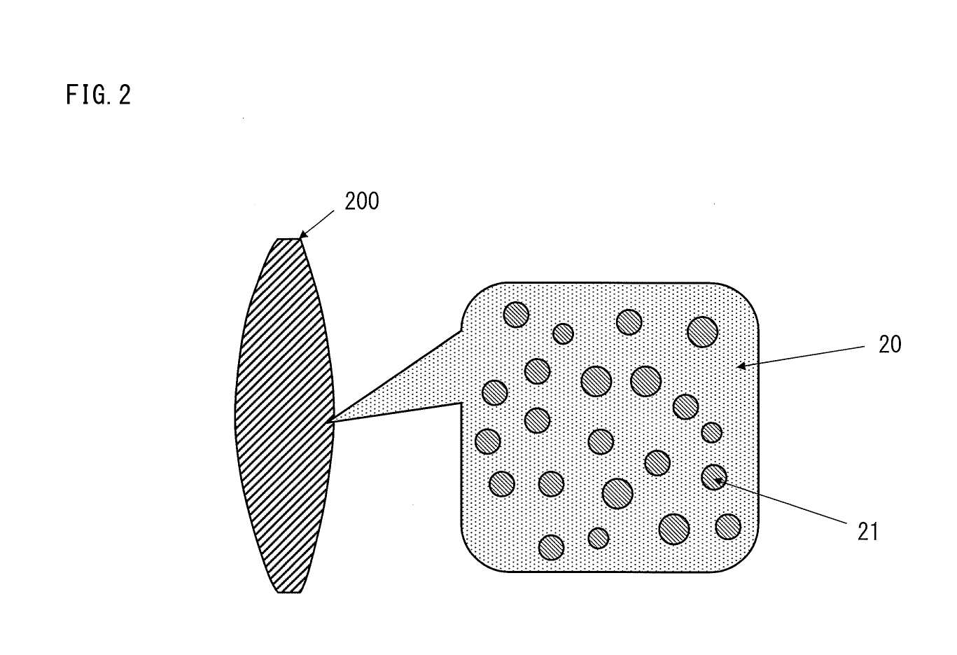

Hereinafter, an embodiment is described with reference to FIGS. 2 to 16.

### 1. Configuration

[1-1. Configuration of Optical Lens]

FIG. 2 is a schematic cross-sectional diagram showing a nanocomposite material, and an optical lens composed of the nanocomposite material. The optical lens 200 is formed of the nanocomposite material. The nanocomposite material forming the optical lens 200 includes a matrix 20 composed of a resin material, and nano-fine particles 21 dispersed in the matrix 20. The nano-fine particles 21 include at least one selected from SiC, ZnS and Si₃N₄.

[1-2. Nano-Fine Particles]

The nano-fine particles 21 are uniformly dispersed in the matrix 20 composed of a resin material. The nanocomposite material in which the nano-fine particles 21 each being sufficiently smaller than the wavelength of light are uniformly dispersed can be regarded as a homogeneous medium without variations in the refractive index. In the visible-light region, it is beneficial that the particle diameter of the nano-fine particles 21 is 400 nm or less. When the particle diameter is smaller than one fourth of the wavelength of light, Rayleigh scattering can be suppressed. Therefore, when higher light transmittance is required, it is beneficial that the particle diameter of the nano-fine particles 21 is 100 nm or less in the visible-light region. In order to uniformly disperse such very small nano-fine particles, it is beneficial that the surface of each nano-fine particle is subjected to surface modification or coated with a dispersant to suppress aggregation of the nano-fine particles.

It is beneficial that the nano-fine particles 21 including at least one selected from SiC, ZnS and Si₃N₄, which are used in the nanocomposite material of the present embodiment, are: multiple kinds of nano-fine particles including nano-fine particles formed of at least one selected from SiC, ZnS and Si₃N₄, and nano-fine particles formed of at least one selected from Al₂O₃, ZrO₂, C and AlN; or hybrid nano-fine particles in which at least one selected from Al₂O₃, ZrO₂, C and AlN is added to at least one selected from SiC, ZnS and Si₃N₄; or hybrid nano-fine particles in which at least one selected from SiC, ZnS and Si₃N₄ is added to at least one selected from Al₂O₃, ZrO₂, C and AlN. The method for forming the nano-fine particles 21 is not particularly limited. A liquid phase method such as a coprecipitation method, a sol-gel method, or metal complex decomposition or a vapor phase method such as vapor deposition, CVD, sputtering, or ion plating can be adopted. Alternatively, the nano-fine particles 21 may be formed by a grinding method using a ball mill or a bead mill.

Hereinafter, SiC-C hybrid nano-fine particles in which C is added to SiC are described. The SiC-C hybrid nano-fine particles can be easily formed by sputtering, specifically, by placing a chip target of C on an SiC target, and sputtering the targets at the same time. The composition of the SiC-C hybrid nano-fine particles can be freely controlled by the area ratio of the chip target of C.

[1-3. Matrix Composed of Resin Material]

As the matrix 20 composed of a resin material, a resin having a high light transmittance selected from resins such as thermoplastic resins, thermosetting resins, and energy ray-curable resins can be used. For example, acrylic acid resins, methacrylic acid resins, epoxy resins, polyester resins, polystyrene resins, polyolefin resins, polyamide resins, polyimide resins, polyvinyl alcohol, butyral resins, vinyl acetate resins, alicyclic polyolefin resins, and the like can be used. Besides, engineering plastics such as polycarbonate, liquid crystal polymers, polyphenylene ether, polysulfone, polyether sulfone, polyarylate, and amorphous polyolefin can also be used. Further, silicone resins and the like can also be used. Mixtures and copolymers of these resins may also be used. Resins obtained by modifying these resins may also be used. The matrix 20 composed of a resin material is not particularly limited, and the present disclosure is not intended to restrict the subject matter of the scope of claim for patent.

### 2. Function

[2-1. Optical Property of Nano-Fine Particles]

In the present disclosure, the optical properties of the SiC-C hybrid nano-fine particles are evaluated by measuring the refractive index of an SiC-C thin film obtained by placing four chip targets of C having a size of 10 mm×10 mm on an SiC target having a diameter of 2 inches (50.8 mm) and sputtering the targets to deposit SiC-C nano-fine particles to a thickness of about 1 μm. The measurement is performed by DPSD (Differential Power Spectral Density) using a non-contact optical thin-film measuring system (FilmTek 4000, manufactured by Scientific Computing International).

Based on the measurement result of the refractive index of the SiC-C hybrid nano-fine particles, and a refractive index nF of the SiC-C thin film to the F-line (wavelength: 486.13 nm), a refractive index nd thereof to the d-line (wavelength: 587.56 nm), and a refractive index nC thereof to the C-line (wavelength: 656.27 nm), an Abbe number νd of the SiC-C thin film to the d-line is calculated according to the following formula (1). The result is shown in Table 1.

νd=(nd−1)/(nF−nC) (1)

TABLE 1

| Kinds of | Wavelength | Optical property of |
|---|---|---|
| refractive index | (nm) | SiC—C thin film |
| nF | 486.13 | 3.18819 |
| nd | 587.56 | 3.18659 |
| nC | 656.27 | 3.09475 |

| | |
|---|---|
| νd | 23.401 |

As shown in Table 1, it is confirmed that the SiC-C thin film is a material having a very high Abbe number νd of about 23.4 while the refractive index nd exceeds 3.

It is found that the SiC-C thin film is a material containing SiC, and therefore, has the high Abbe number as well as the high refractive index. For the same reason, a material containing ZnS and a material containing Si₃N₄ also have a high refractive index and a high Abbe number.

Hereinafter, the optical properties of nanocomposite materials each using nano-fine particles including each of SiC, ZnS and Si₃N₄ are described.

[2-2. Optical Property of Nanocomposite Material: SiC]

As the matrix 20 composed of a resin material, a cured polymer is obtained by adding a commercially available polymerization initiator to a commercially available polyolefin ultraviolet-curable resin, and irradiating the resin with an ultraviolet ray emitted from an UV lamp to polymerize and cure the resin. The optical properties (nF, nd, nC, and νd) of the cured polymer are shown in Table 2.

TABLE 2
Optical property of cured polymer

| nF | nd | nC | νd |
|---|---|---|---|
| 1.51686 | 1.51104 | 1.50857 | 61.645 |

An average refractive index n_{X} of the nanocomposite material at a wavelength λ can be roughly calculated according to the following formula (2), based on the Lorentz theory, using a refractive index n₁ of the nano-fine particles 21, a refractive index n₀ of the matrix 20 composed of a resin material, and a volume ratio k of the nano-fine particles 21 to the entire nanocomposite material, at the wavelength λ.

(n_{X}²−1)(n_{X}²+2)=k×(n₁²−1)/(n₁²+2)+(1−k)×(n₀²−1)/(n₀²+2) (2)

Usually, a dispersant or the like is included in the nanocomposite material, besides the matrix 20 composed of a resin material and the nano-fine particles 21. Therefore, the optical properties of the actual nanocomposite material are not exactly the same as the values roughly calculated by the above formula (2). However, the actual values do not very much deviate from the calculated values, and the magnitude relationship can be approximately evaluated according to formula (2).

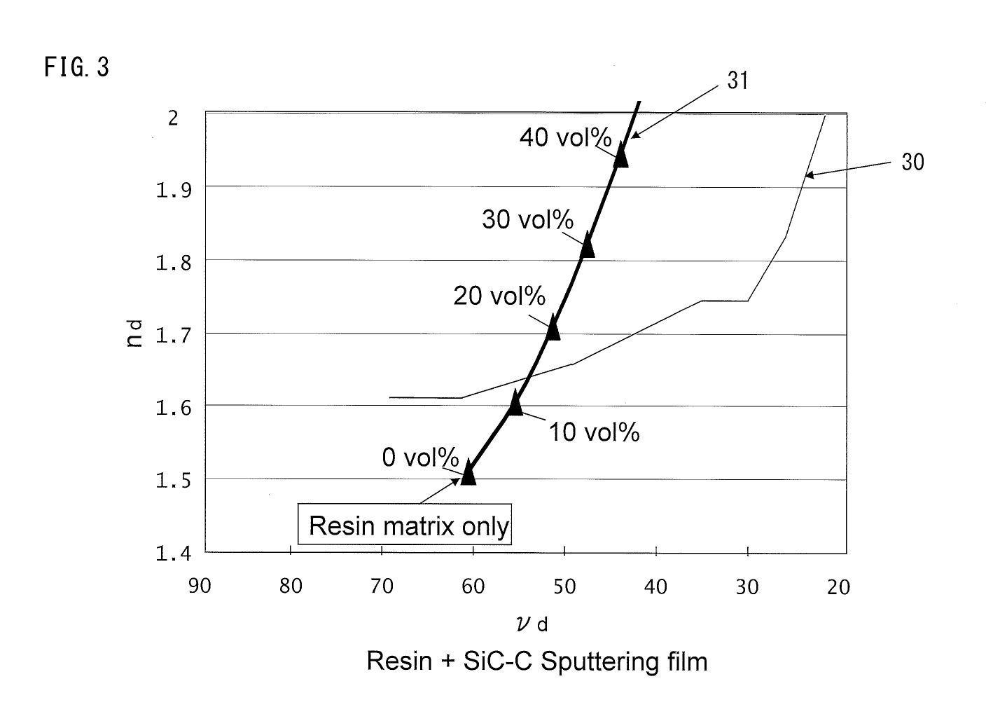

Based on the optical properties of the SiC-C hybrid nano-fine particles obtained by placing four chip targets of C having a size of 10 mm×10 mm on an SiC target having a diameter of 2 inches (50.8 mm) and sputtering the targets to deposit SiC-C nano-fine particles to a thickness of about 1 μm, and refractive index data of a commercially available polyolefin resin, change in the nd-νd relationship of the nanocomposite material is examined with the content of the nano-fine particles being gradually increased from 0 vol. % to 40 vol. % by 10 vol. %. The result is shown in the graph of FIG. 3.

In FIG. 3, a line 30 indicates a boundary between a region to which a La glass belongs and a region to which other glass belongs, and a region on the upper left side of the line 30 is the region to which the La glass belongs. A graph 31 indicates the nd-νd relationship of the nanocomposite material containing the SiC-C hybrid nano-fine particles, and is obtained by connecting, with a line, the values when the content of the SiC-C hybrid nano-fine particles is 0, 10, 20, 30, and 40 vol. %, respectively. With reference to FIG. 3, for example, in the case of the nanocomposite material containing 20 vol. % of SiC-C hybrid nano-fine particles, nd=1.7 and νd=50. When the content of SiC-C hybrid nano-fine particles exceeds about 10 vol. %, an intended nanocomposite material having a high refractive index and a high Abbe number, which is included in the region to which the La glass (glass categorized as LaK glass, LaF glass, and LaSF glass in the optical glass classification) belongs, can be obtained.

Also in the case of using multiple kinds of nano-fine particles including SiC nano-fine particles and C nano-fine particles, a nanocomposite material having a high refractive index and a high Abbe number can be obtained as in the case of the SiC-C hybrid nano-fine particles. The refractive index of an SiC thin film formed under the same condition as that for the SiC-C thin film is measured by DPSD using the non-contact optical thin-film measuring system. Based on the refractive index of the SiC thin film and refractive index data of a C thin film (data from Refractivelndex.INFO-Refractive index database), νd of the SiC thin film and νd of the C thin film are calculated according to the above formula (1). The result is shown in Table 3.

TABLE 3

Optical property

| Material | nF | nd | nC | νd |
|---|---|---|---|---|
| SiC | 3.38636 | 3.18322 | 3.10824 | 7.850 |
| C | 2.43555 | 2.41748 | 2.40990 | 55.260 |

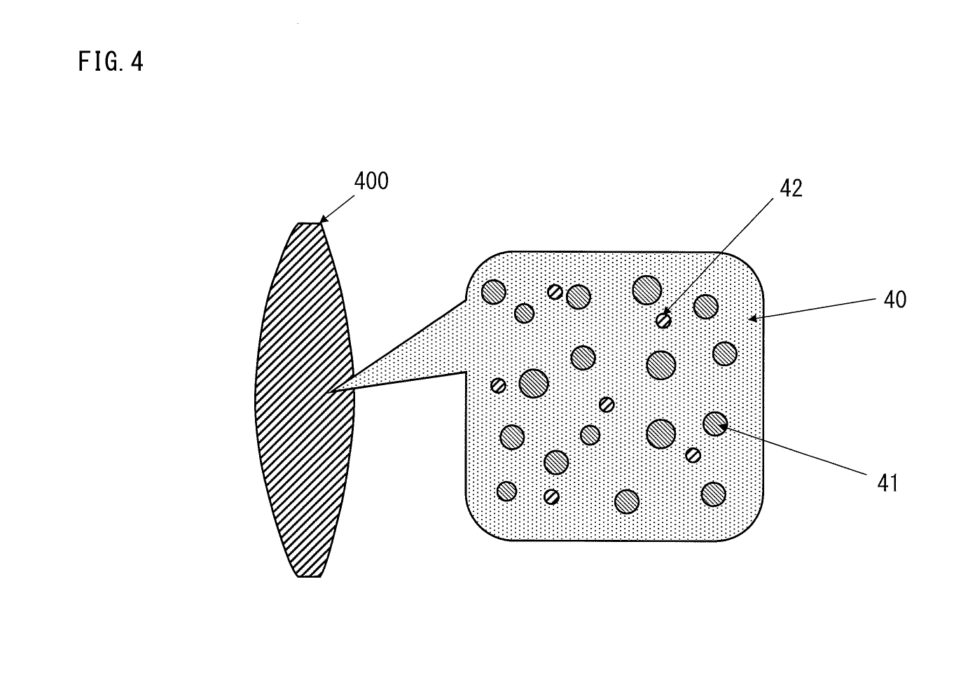

FIG. 4 is a schematic cross-sectional diagram showing a nanocomposite material, and an optical lens composed of the nanocomposite material. The optical lens 400 is formed of the nanocomposite material. The nanocomposite material forming the optical lens 400 contains a matrix 40 composed of a resin material, and one kind of nano-fine particles 41 and the other kind of nano-fine particles 42 which are dispersed in the matrix 40. The nano-fine particles 41 are nano-fine particles formed of at least one selected from SiC, ZnS and Si₃N₄, and the nano-fine particles 42 are nano-fine particles formed of at least one selected from Al₂O₃, ZrO₂, C and AlN, for example.

As the matrix 40 composed of a resin material, any of the resins exemplified for the matrix 20 composed of a resin material can be used. The matrix 40 composed of a resin material is not particularly limited, and the present disclosure is not intended to restrict the subject matter of the scope of claim for patent.

An average refractive index n_{X} of the nanocomposite material at a wavelength λ, can be roughly calculated according to the following formula (3), based on the Lorentz theory, using a refractive index n₁ of the one kind of nano-fine particles 41, a refractive index n₂ of the other kind of nano-fine particles 42, a refractive index n₀ of the matrix 40 composed of a resin material, a volume ratio k₁ of the one kind of nano-fine particles 41 to the entire nanocomposite material, and a volume ratio k₂ of the other kind of nano-fine particles 42 to the entire nanocomposite material, at the wavelength λ.

(n_{X}²−1)/(n_{X}²+2)=k₁×(n₁²−1)/(n₁²+2)+k₂×(n₂²−1)/(n₂²+2)+(1−k₁−k₂)×(n₀²−1)/(n₀²+2) (3)

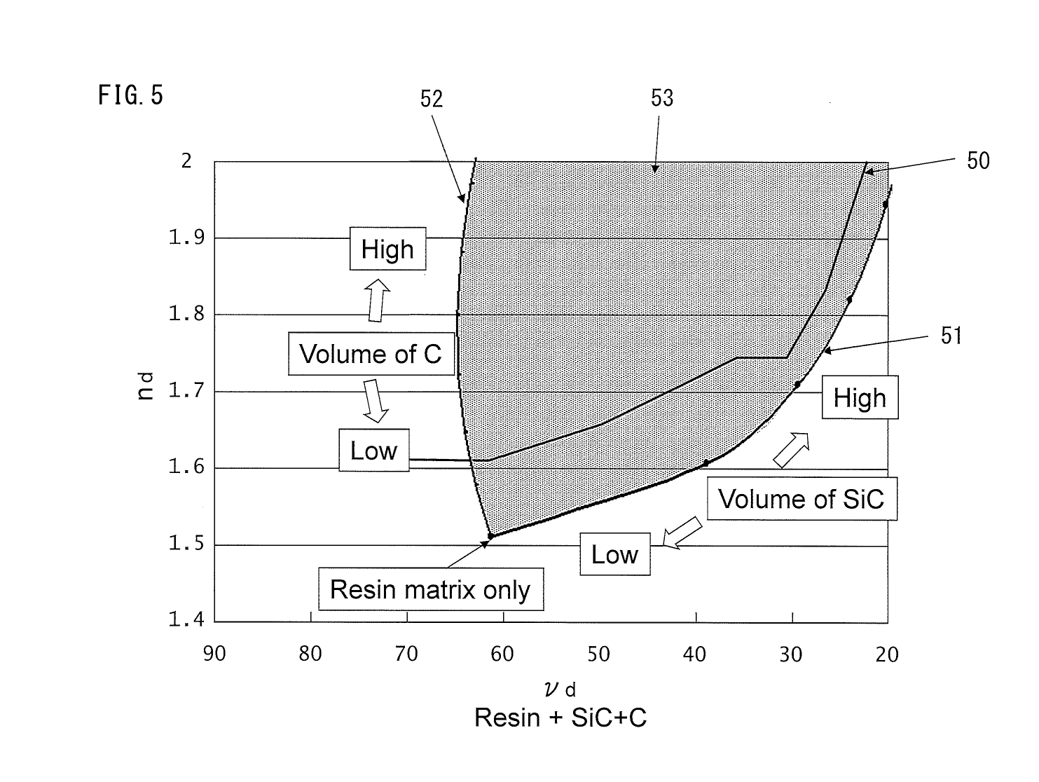

FIG. 5 is a graph showing the nd-νd relationship of a formed nanocomposite material when the volume fractions of SiC nano-fine particles and C nano-fine particles are varied, using the value roughly calculated by the above formula (3).

In FIG. 5, a line 50 indicates a boundary between a region to which a La glass belongs and a region of other glass, and a region on the upper left side of the line 50 is the region to which the La glass belongs. A graph 51 indicates the nd-νd relationship in the case where the volume of SiC nano-fine particles contained in a nanocomposite material in which only the SiC nano-fine particles are dispersed in a matrix composed of a resin material is varied. A graph 52 indicates the nd-νd relationship in the case where the volume of C nano-fine particles contained in a nanocomposite material in which only the C nano-fine particles are dispersed in a matrix composed of a resin material is varied.

In FIG. 5, a hatched region 53 enclosed by the graph 51 and the graph 52 is a region indicating the optical properties that can be obtained when the volume fractions of SiC nano-fine particles and C nano-fine particles are varied in a nanocomposite material in which the SiC nano-fine particles and the C nano-fine particles are dispersed in a matrix composed of a resin material. That is, by appropriately adjusting the volume fractions of the SiC nano-fine particles and the C nano-fine particles, it is possible to obtain a nanocomposite material having the optical properties in the region 53.

Further, as shown in FIG. 5, the region 53 exists also in the region on the upper left side of the line 50, to which the La glass belongs. That is, by appropriately adjusting the volume fractions of the SiC nano-fine particles and the C nano-fine particles, it is possible to obtain a nanocomposite material having the optical properties in the region on the upper left side of the line 50, to which the La glass belongs.

Further, it is confirmed that the nd-νd value of the nanocomposite material in which SiC-C hybrid nano-fine particles are dispersed in the commercially available polyolefin resin shown in FIG. 3 is in the region 53. Thus, it is found that a nanocomposite material having a high refractive index and a high Abbe number can be obtained in both cases where the SiC-C hybrid nano-fine particles are used and where the multiple kinds of nano-fine particles including the SiC nano-fine particles and the C nano-fine particles are used.

It is considered that SiC is necessary in order to obtain a nanocomposite material having a high refractive index and a high Abbe number, and having various combinations of nd and νd. This is because, as shown by the graph 52, the Abbe number cannot be significantly changed with C alone. In other words, by varying the amount of C added to SiC, it is possible to obtain a nanocomposite material having the optical properties in substantially the entirety of the region to which the La glass (glass categorized as LaK glass, LaF glass, and LaSF glass in the optical glass classification) belongs.

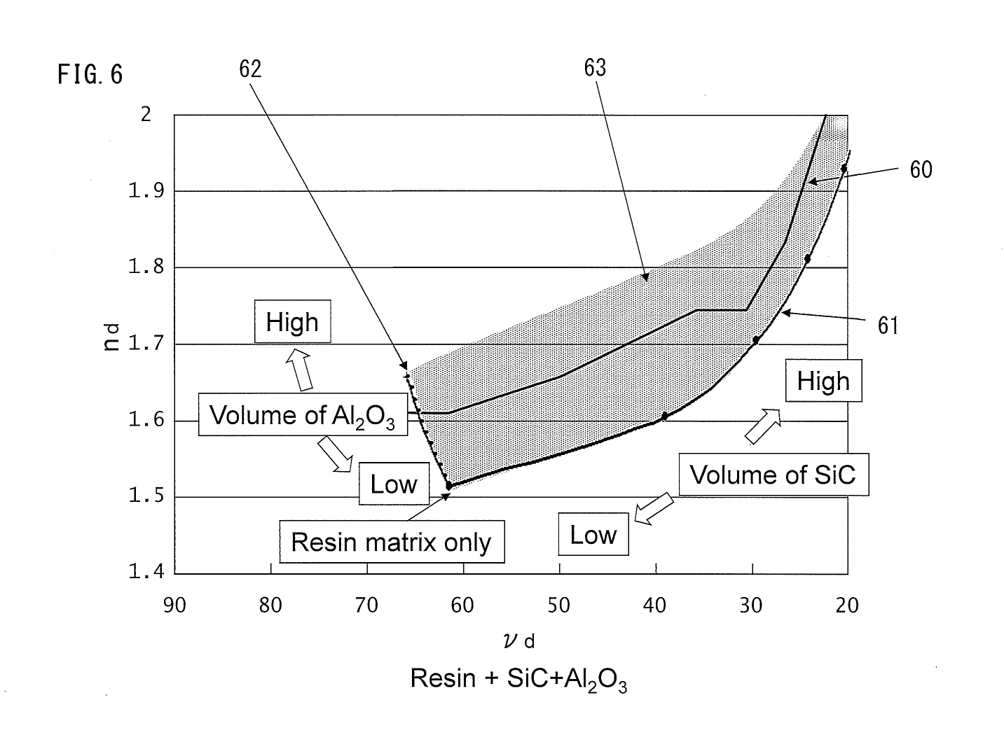

Next, with reference to FIGS. 6 to 8, the optical properties of a nanocomposite material in which Al₂O₃, ZrO₂ or AlN is added to SiC are described. The nd-νd relationship is shown in a similar manner to FIG. 5, using values roughly calculated by the above formula (3).

FIG. 6 is a graph showing the nd-νd relationship of a formed nanocomposite material when the volume fractions of SiC nano-fine particles and Al₂O₃ nano-fine particles are varied.

In FIG. 6, a line 60 indicates a boundary between a region to which a La glass belongs and a region of other glass, and a region on the upper left side of the line 60 is the region to which the La glass belongs. A graph 61 indicates the nd-νd relationship in the case where the volume of SiC nano-fine particles contained in a nanocomposite material in which only the SiC nano-fine particles are dispersed in a matrix composed of a resin material is varied. A graph 62 indicates the nd-νd relationship in the case where the volume of Al₂O₃ nano-fine particles contained in a nanocomposite material in which only the Al₂O₃ nano-fine particles are dispersed in a matrix composed of a resin material is varied.

In FIG. 6, a hatched region 63 enclosed by the graph 61 and the graph 62 is a region indicating the optical properties that can be obtained when the volume fractions of SiC nano-fine particles and Al₂O₃ nano-fine particles are varied in a nanocomposite material in which the SiC nano-fine particles and the Al₂O₃ nano-fine particles are dispersed in a matrix composed of a resin material. That is, by appropriately adjusting the volume fractions of the SiC nano-fine particles and the Al₂O₃ nano-fine particles, it is possible to obtain a nanocomposite material having the optical properties in the region 63.

Further, as shown in FIG. 6, the region 63 exists also in the region on the upper left side of the line 60, to which the La glass belongs. That is, by appropriately adjusting the volume fractions of the SiC nano-fine particles and the Al₂O₃ nano-fine particles, it is possible to obtain a nanocomposite material having the optical properties in the region on the upper left side of the line 60, to which the La glass belongs.

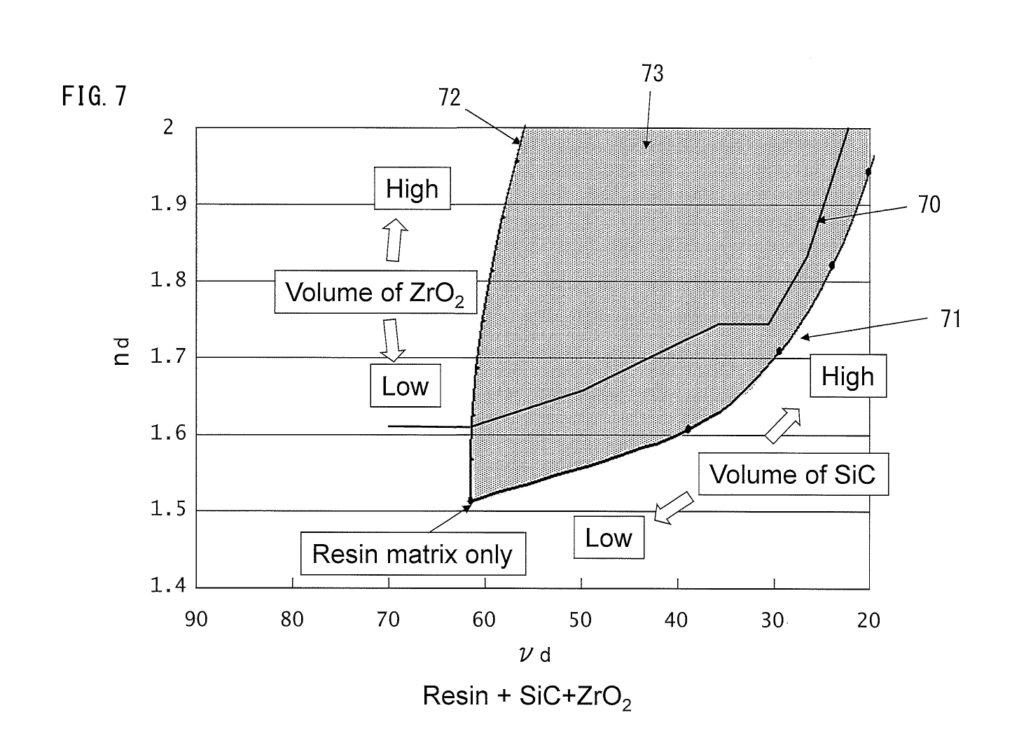

FIG. 7 is a graph showing the nd-νd relationship of a formed nanocomposite material when the volume fractions of SiC nano-fine particles and ZrO₂ nano-fine particles are varied.

In FIG. 7, a line 70 indicates a boundary between a region to which a La glass belongs and a region of other glass, and a region on the upper left side of the line 70 is the region to which the La glass belongs. A graph 71 indicates the nd-νd relationship in the case where the volume of SiC nano-fine particles contained in a nanocomposite material in which only the SiC nano-fine particles are dispersed in a matrix composed of a resin material is varied. A graph 72 indicates the nd-νd relationship in the case where the volume of ZrO₂ nano-fine particles contained in a nanocomposite material in which only the ZrO₂ nano-fine particles are dispersed in a matrix composed of a resin material is varied.

In FIG. 7, a hatched region 73 enclosed by the graph 71 and the graph 72 is a region indicating the optical properties that can be obtained when the volume fractions of SiC nano-fine particles and ZrO₂ nano-fine particles are varied in a nanocomposite material in which the SiC nano-fine particles and the ZrO₂ nano-fine particles are dispersed in a matrix composed of a resin material. That is, by appropriately adjusting the volume fractions of the SiC nano-fine particles and the ZrO₂ nano-fine particles, it is possible to obtain a nanocomposite material having the optical properties in the region 73.

Further, as shown in FIG. 7, the region 73 exists also in the region on the upper left side of the line 70, to which the La glass belongs. That is, by appropriately adjusting the volume fractions of the SiC nano-fine particles and the ZrO₂ nano-fine particles, it is possible to obtain a nanocomposite material having the optical properties in the region on the upper left side of the line 70, to which the La glass belongs.

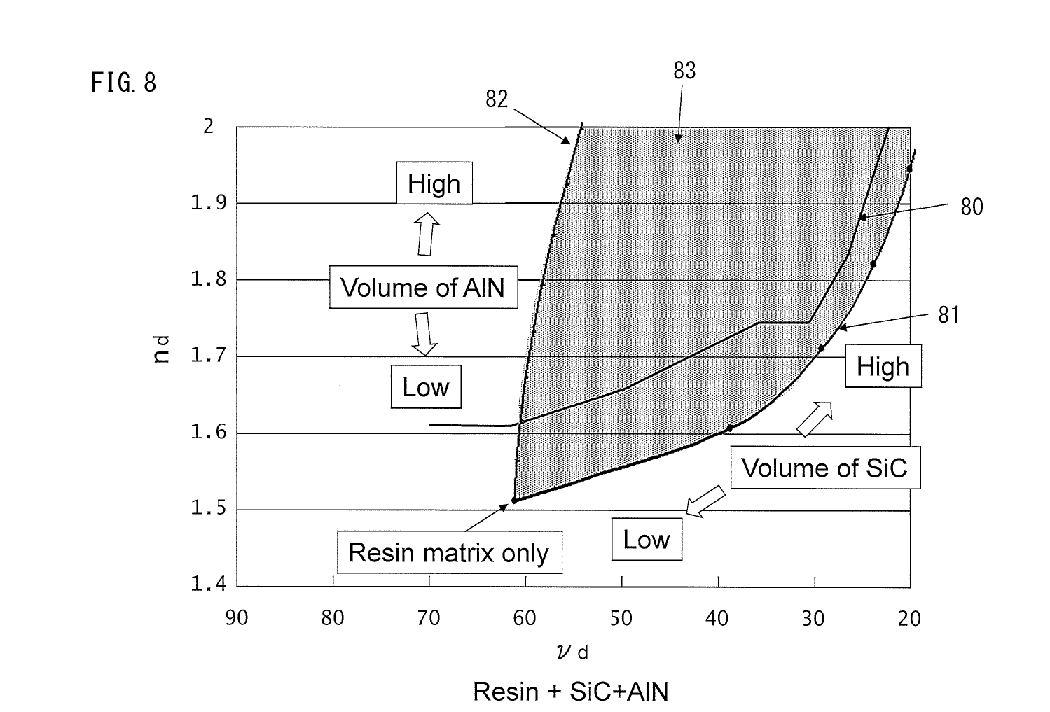

FIG. 8 is a graph showing the nd-νd relationship of a formed nanocomposite material when the volume fractions of SiC nano-fine particles and AlN nano-fine particles are varied.

In FIG. 8, a line 80 indicates a boundary between a region to which a La glass belongs and a region of other glass, and a region on the upper left side of the line 80 is the region to which the La glass belongs. A graph 81 indicates the nd-νd relationship in the case where the volume of SiC nano-fine particles contained in a nanocomposite material in which only the SiC nano-fine particles are dispersed in a matrix composed of a resin material is varied. A graph 82 indicates the nd-νd relationship in the case where the volume of AlN nano-fine particles contained in a nanocomposite material in which only the AlN nano-fine particles are dispersed in a matrix composed of a resin material is varied.

In FIG. 8, a hatched region 83 enclosed by the graph 81 and the graph 82 is a region indicating the optical properties that can be obtained when the volume fractions of SiC nano-fine particles and AlN nano-fine particles are varied in a nanocomposite material in which the SiC nano-fine particles and the AlN nano-fine particles are dispersed in a matrix composed of a resin material. That is, by appropriately adjusting the volume fractions of the SiC nano-fine particles and the AlN nano-fine particles, it is possible to obtain a nanocomposite material having the optical properties in the region 83.

Further, as shown in FIG. 8, the region 83 exists also in the region on the upper left side of the line 80, to which the La glass belongs. That is, by appropriately adjusting the volume fractions of the SiC nano-fine particles and the AlN nano-fine particles, it is possible to obtain a nanocomposite material having the optical properties in the region on the upper left side of the line 80, to which the La glass belongs.

It is apparent from FIGS. 6 to 8 that, when using the nano-fine particles containing SiC, an intended nanocomposite material having a high refractive index and a high Abbe number, which is included in the region to which the La glass belongs, can be obtained. Further, it is found that, by adding Al₂O₃, ZrO₂ or AlN to SiC as in the case where C is added to SiC, a nanocomposite material included in a wider region to which the La glass belongs can be obtained.

As described above, in the case where the nano-fine particles containing SiC are dispersed in the resin material, for example, the content of the nano-fine particles in the resin material is beneficially 10 vol. % or more, and more beneficially, 12 vol. % or more, thereby obtaining a nanocomposite material having a high refractive index and a high Abbe number. In the case where the nano-fine particles containing SiC and at least one of C, Al₂O₃, ZrO₂ and AlN are dispersed in the resin material, it is beneficial to appropriately adjust the ratio between SiC and at least one of C, Al₂O₃, ZrO₂ and AlN, in view of the refractive index and the Abbe number of the intended optical glass.

[2-3. Optical Property of Nanocomposite Material: ZnS and Si₃N₄]

As in the case of the nanocomposite material using the nano-fine particles containing SiC, nano-fine particles containing ZnS and nano-fine particles containing Si₃N₄ can also be used in order to obtain a nanocomposite material having a high refractive index and a high Abbe number and included in the region to which the La glass belongs. The optical properties of ZnS and Si₃N₄ are shown in Table 4.

TABLE 4

Optical property

| Material | nF | nd | nC | νd |
|---|---|---|---|---|
| ZnS | 2.62951 | 2.57152 | 2.55035 | 19.850 |
| Si₃N₄ | 2.03821 | 2.01673 | 2.00778 | 33.410 |

First, a nanocomposite material using the nano-fine particles containing ZnS is described.

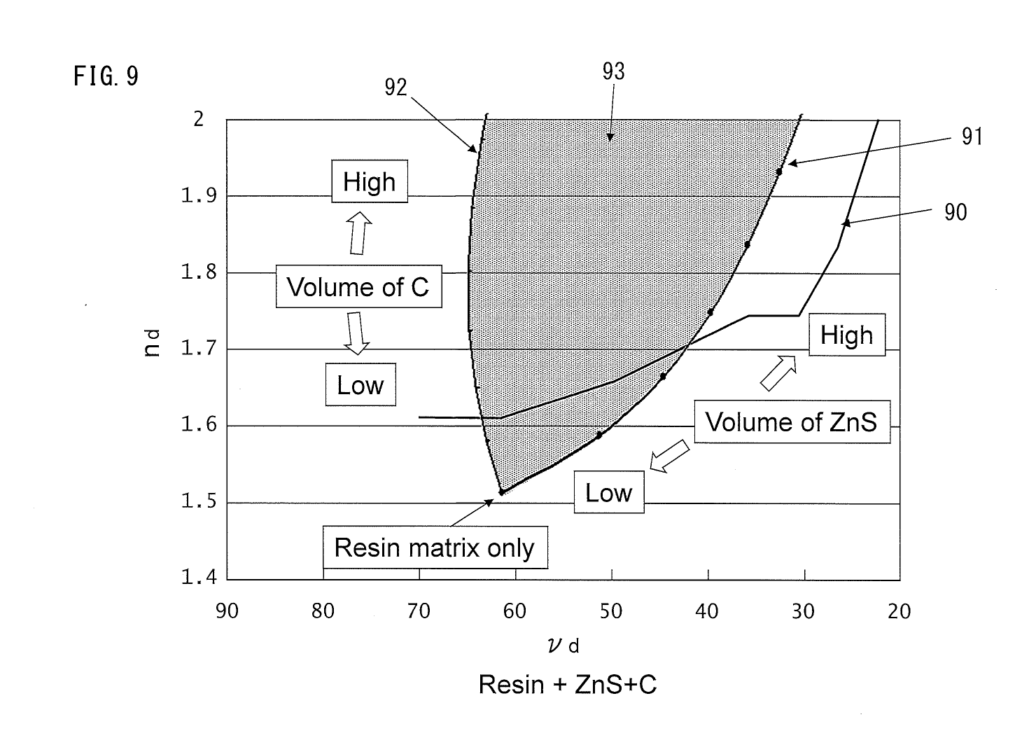

FIG. 9 is a graph showing the nd-νd relationship of a formed nanocomposite material when the volume fractions of ZnS nano-fine particles and C nano-fine particles are varied.

In FIG. 9, a line 90 indicates a boundary between a region to which a La glass belongs and a region of other glass, and a region on the upper left side of the line 90 is the region to which the La glass belongs. A graph 91 indicates the nd-νd relationship in the case where the volume of ZnS nano-fine particles contained in a nanocomposite material in which only the ZnS nano-fine particles are dispersed in a matrix composed of a resin material is varied. A graph 92 indicates the nd-νd relationship in the case where the volume of C nano-fine particles contained in a nanocomposite material in which only the C nano-fine particles are dispersed in a matrix composed of a resin material is varied.

In FIG. 9, a hatched region 93 enclosed by the graph 91 and the graph 92 is a region indicating the optical properties that can be obtained when the volume fractions of ZnS nano-fine particles and C nano-fine particles are varied in a nanocomposite material in which the ZnS nano-fine particles and the C nano-fine particles are dispersed in a matrix composed of a resin material. That is, by appropriately adjusting the volume fractions of the ZnS nano-fine particles and the C nano-fine particles, it is possible to obtain a nanocomposite material having the optical properties in the region 93.

Further, as shown in FIG. 9, the region 93 exists also in the region on the upper left side of the line 90, to which the La glass belongs. That is, by appropriately adjusting the volume fractions of the ZnS nano-fine particles and the C nano-fine particles, it is possible to obtain a nanocomposite material having the optical properties in the region on the upper left side of the line 90, to which the La glass belongs.

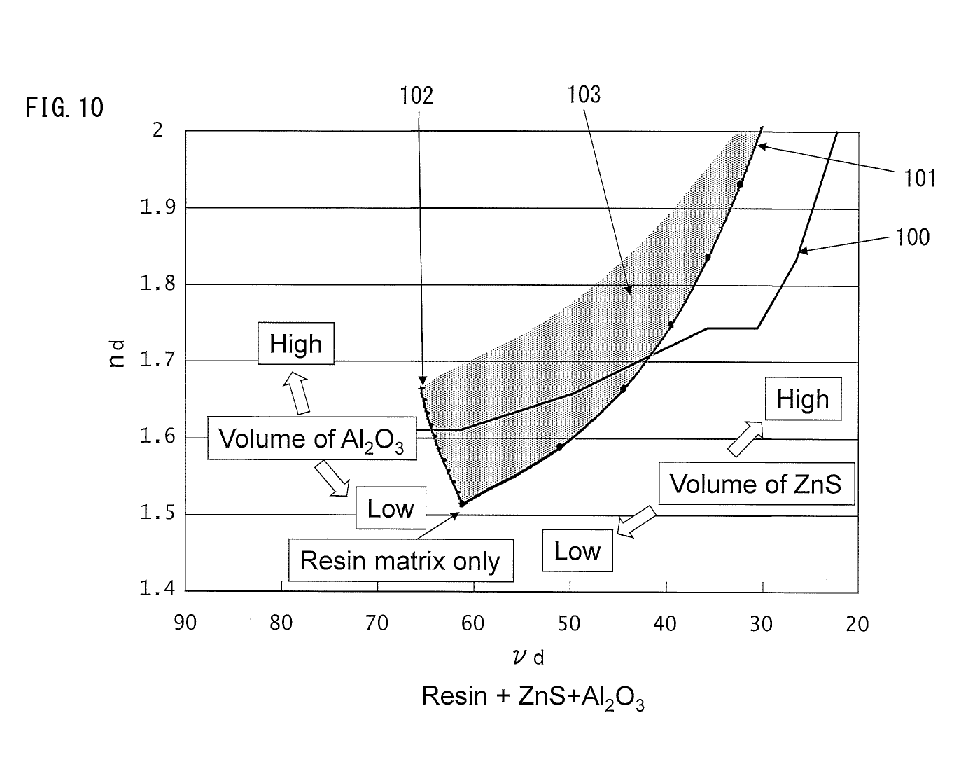

FIG. 10 is a graph showing the nd-νd relationship of a formed nanocomposite material when the volume fractions of ZnS nano-fine particles and Al₂O₃ nano-fine particles are varied.

In FIG. 10, a line 100 indicates a boundary between a region to which a La glass belongs and a region of other glass, and a region on the upper left side of the line 100 is the region to which the La glass belongs. A graph 101 indicates the nd-νd relationship in the case where the volume of ZnS nano-fine particles contained in a nanocomposite material in which only the ZnS nano-fine particles are dispersed in a matrix composed of a resin material is varied. A graph 102 indicates the nd-νd relationship in the case where the volume of Al₂O₃ nano-fine particles contained in a nanocomposite material in which only the Al₂O₃ nano-fine particles are dispersed in a matrix composed of a resin material is varied.

In FIG. 10, a hatched region 103 enclosed by the graph 101 and the graph 102 is a region indicating the optical properties that can be obtained when the volume fractions of ZnS nano-fine particles and Al₂O₃ nano-fine particles are varied in a nanocomposite material in which the ZnS nano-fine particles and the Al₂O₃ nano-fine particles are dispersed in a matrix composed of a resin material. That is, by appropriately adjusting the volume fractions of the ZnS nano-fine particles and the Al₂O₃ nano-fine particles, it is possible to obtain a nanocomposite material having the optical properties in the region 103.

Further, as shown in FIG. 10, the region 103 exists also in the region on the upper left side of the line 100, to which the La glass belongs. That is, by appropriately adjusting the volume fractions of the ZnS nano-fine particles and the Al₂O₃ nano-fine particles, it is possible to obtain a nanocomposite material having the optical properties in the region on the upper left side of the line 100, to which the La glass belongs.

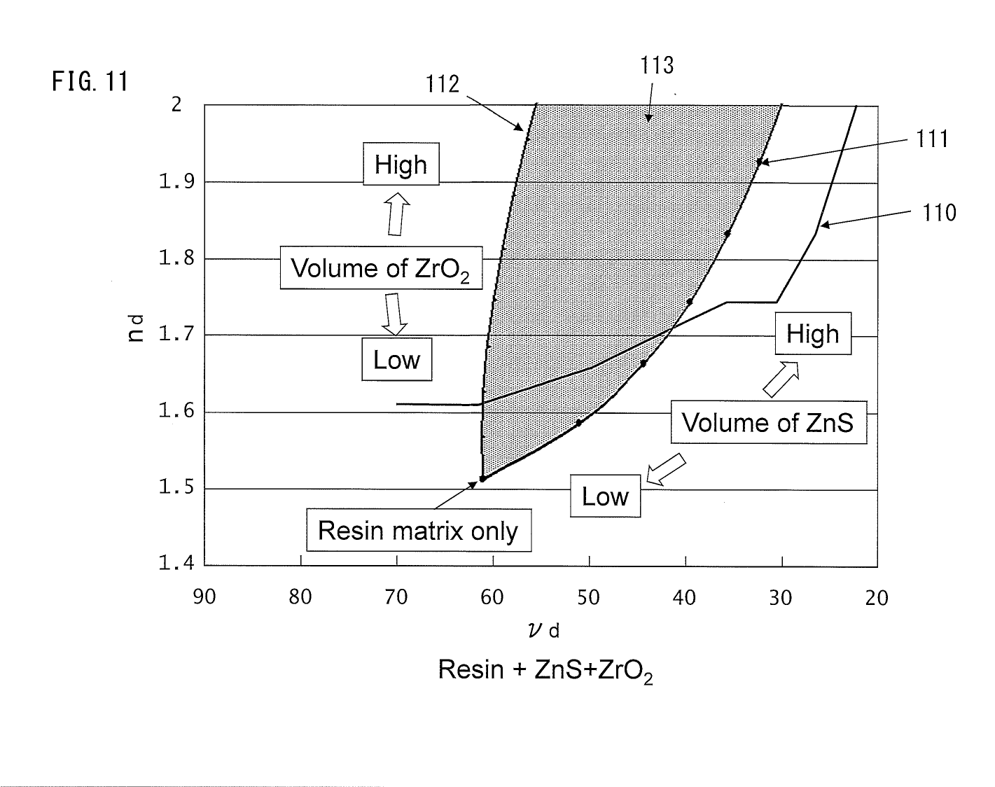

FIG. 11 is a graph showing the nd-νd relationship of a formed nanocomposite material when the volume fractions of ZnS nano-fine particles and ZrO₂ nano-fine particles are varied.

In FIG. 11, a line 110 indicates a boundary between a region to which a La glass belongs and a region of other glass, and a region on the upper left side of the line 110 is the region to which the La glass belongs. A graph 111 indicates the nd-νd relationship in the case where the volume of ZnS nano-fine particles contained in a nanocomposite material in which only the ZnS nano-fine particles are dispersed in a matrix composed of a resin material is varied. A graph 112 indicates the nd-νd relationship in the case where the volume of ZrO₂ nano-fine particles contained in a nanocomposite material in which only the ZrO₂ nano-fine particles are dispersed in a matrix composed of a resin material is varied.

In FIG. 11, a hatched region 113 enclosed by the graph 111 and the graph 112 is a region indicating the optical properties that can be obtained when the volume fractions of ZnS nano-fine particles and ZrO₂ nano-fine particles are varied in a nanocomposite material in which the ZnS nano-fine particles and the ZrO₂ nano-fine particles are dispersed in a matrix composed of a resin material. That is, by appropriately adjusting the volume fractions of the ZnS nano-fine particles and the ZrO₂ nano-fine particles, it is possible to obtain a nanocomposite material having the optical properties in the region 113.

Further, as shown in FIG. 11, the region 113 exists also in the region on the upper left side of the line 110, to which the La glass belongs. That is, by appropriately adjusting the volume fractions of the ZnS nano-fine particles and the ZrO₂ nano-fine particles, it is possible to obtain a nanocomposite material having the optical properties in the region on the upper left side of the line 110, to which the La glass belongs.

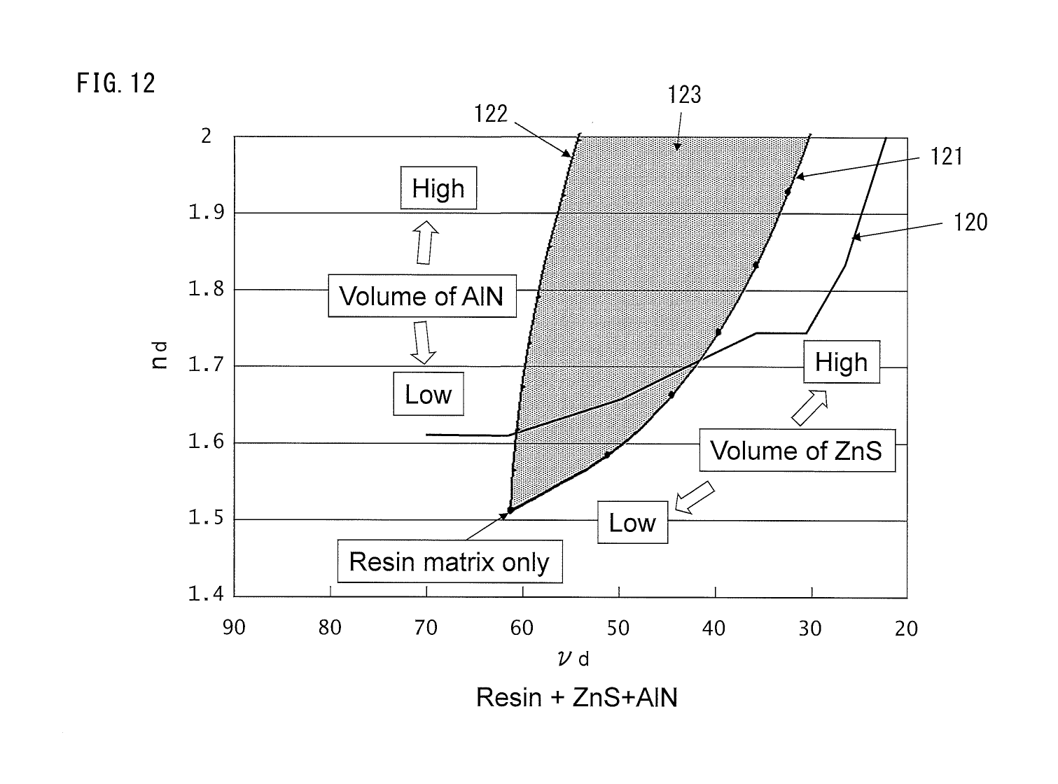

FIG. 12 is a graph showing the nd-νd relationship of a formed nanocomposite material when the volume fractions of ZnS nano-fine particles and AlN nano-fine particles are varied.

In FIG. 12, a line 120 indicates a boundary between a region to which a La glass belongs and a region of other glass, and a region on the upper left side of the line 120 is the region to which the La glass belongs. A graph 121 indicates the nd-νd relationship in the case where the volume of ZnS nano-fine particles contained in a nanocomposite material in which only the ZnS nano-fine particles are dispersed in a matrix composed of a resin material is varied. A graph 122 indicates the nd-νd relationship in the case where the volume of AlN nano-fine particles contained in a nanocomposite material in which only the AlN nano-fine particles are dispersed in a matrix composed of a resin material is varied.

In FIG. 12, a hatched region 123 enclosed by the graph 121 and the graph 122 is a region indicating the optical properties that can be obtained when the volume fractions of ZnS nano-fine particles and AlN nano-fine particles are varied in a nanocomposite material in which the ZnS nano-fine particles and the AlN nano-fine particles are dispersed in a matrix composed of a resin material. That is, by appropriately adjusting the volume fractions of the ZnS nano-fine particles and the AlN nano-fine particles, it is possible to obtain a nanocomposite material having the optical properties in the region 123.

Further, as shown in FIG. 12, the region 123 exists also in the region on the upper left side of the line 120, to which the La glass belongs. That is, by appropriately adjusting the volume fractions of the ZnS nano-fine particles and the AlN nano-fine particles, it is possible to obtain a nanocomposite material having the optical properties in the region on the upper left side of the line 120, to which the La glass belongs.

It is apparent from FIGS. 9 to 12 that, when using the nano-fine particles containing ZnS, an intended nanocomposite material having a high refractive index and a high Abbe number, which is included in the region to which the La glass belongs, can be obtained. Further, it is found that, by adding C, Al₂O₃, ZrO₂ or AlN to ZnS, a nanocomposite material included in a wider region to which the La glass belongs can be obtained.

As described above, in the case where the nano-fine particles containing ZnS are dispersed in the resin material, for example, the content of the nano-fine particles in the resin material is beneficially 10 vol. % or more, and more beneficially, 12 vol. % or more, thereby obtaining a nanocomposite material having a high refractive index and a high Abbe number. In the case where the nano-fine particles containing ZnS and at least one of C, Al₂O₃, ZrO₂ and AlN are dispersed in the resin material, it is beneficial to appropriately adjust the ratio between ZnS and at least one of C, Al₂O₃, ZrO₂ and AlN, in view of the refractive index and the Abbe number of the intended optical glass.

Next, a nanocomposite material using the nano-fine particles containing Si₃N₄ is described.

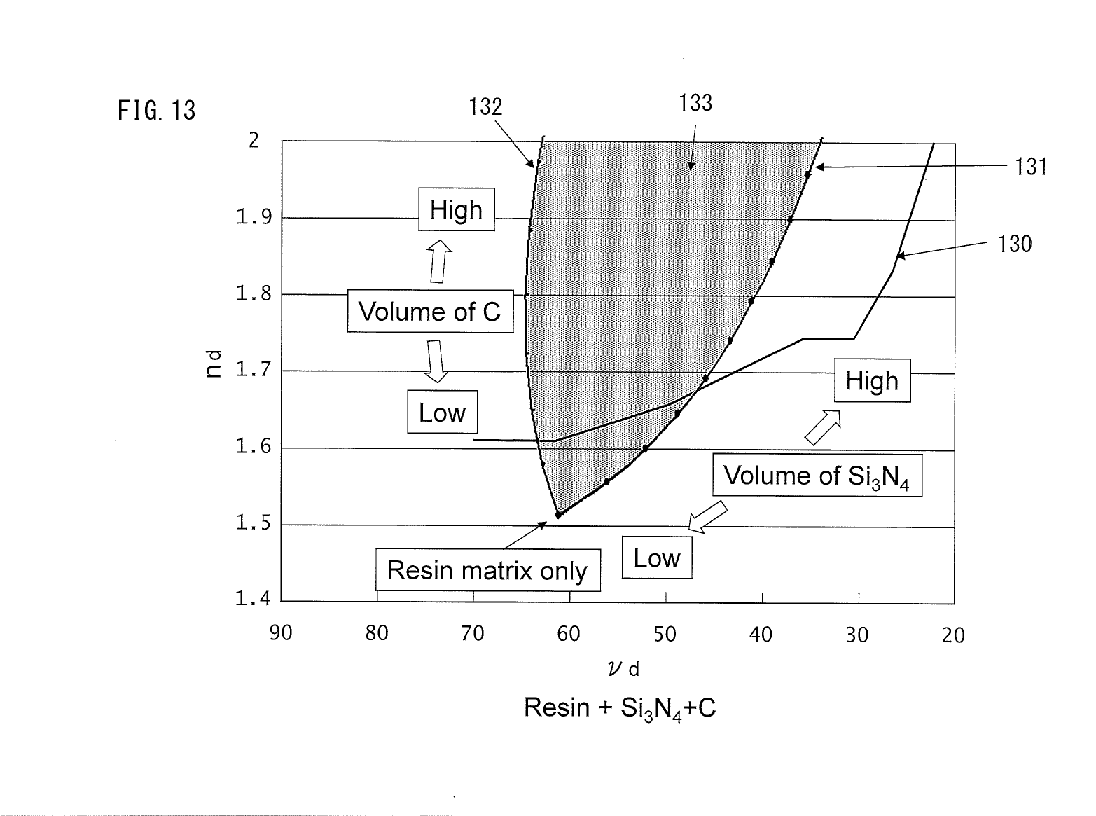

FIG. 13 is a graph showing the nd-νd relationship of a formed nanocomposite material when the volume fractions of Si₃N₄ nano-fine particles and C nano-fine particles are varied.

In FIG. 13, a line 130 indicates a boundary between a region to which a La glass belongs and a region of other glass, and a region on the upper left side of the line 130 is the region to which the La glass belongs. A graph 131 indicates the nd-νd relationship in the case where the volume of Si₃N₄ nano-fine particles contained in a nanocomposite material in which only the Si₃N₄ nano-fine particles are dispersed in a matrix composed of a resin material is varied. A graph 132 indicates the nd-νd relationship in the case where the volume of C nano-fine particles contained in a nanocomposite material in which only the C nano-fine particles are dispersed in a matrix composed of a resin material is varied.

In FIG. 13, a hatched region 133 enclosed by the graph 131 and the graph 132 is a region indicating the optical properties that can be obtained when the volume fractions of Si₃N₄ nano-fine particles and C nano-fine particles are varied in a nanocomposite material in which the Si₃N₄ nano-fine particles and the C nano-fine particles are dispersed in a matrix composed of a resin material. That is, by appropriately adjusting the volume fractions of the Si₃N₄ nano-fine particles and the C nano-fine particles, it is possible to obtain a nanocomposite material having the optical properties in the region 133.

Further, as shown in FIG. 13, the region 133 exists also in the region on the upper left side of the line 130, to which the La glass belongs. That is, by appropriately adjusting the volume fractions of the Si₃N₄ nano-fine particles and the C nano-fine particles, it is possible to obtain a nanocomposite material having the optical properties in the region on the upper left side of the line 130, to which the La glass belongs.

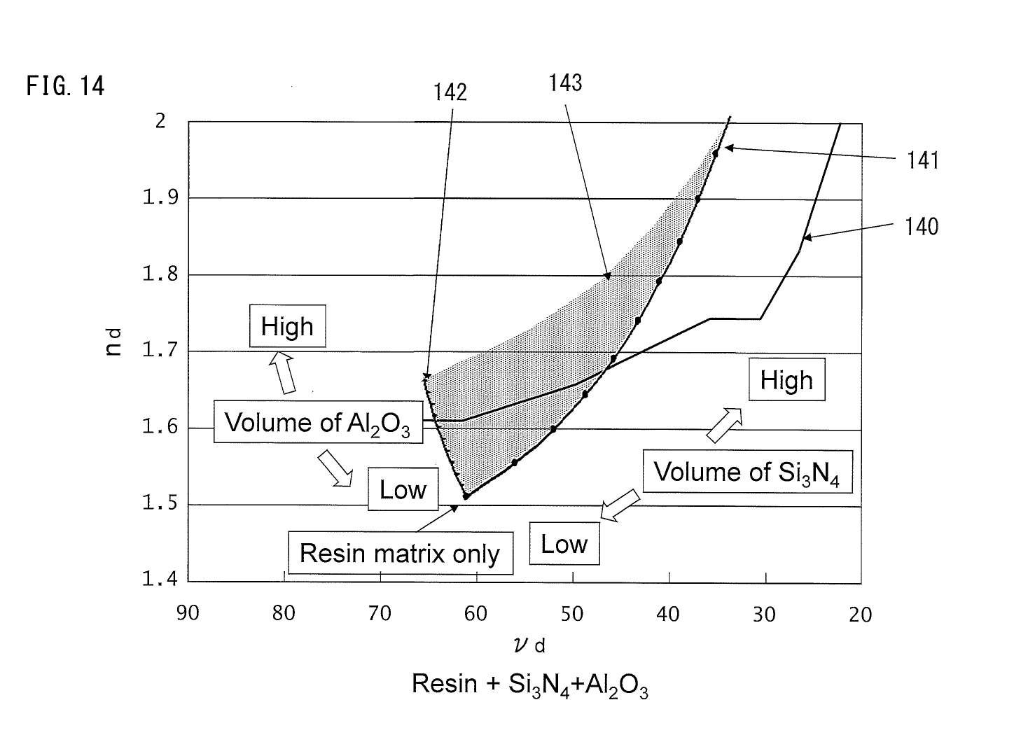

FIG. 14 is a graph showing the nd-νd relationship of a formed nanocomposite material when the volume fractions of Si₃N₄ nano-fine particles and Al₂O₃ nano-fine particles are varied.

In FIG. 14, a line 140 indicates a boundary between a region to which a La glass belongs and a region of other glass, and a region on the upper left side of the line 140 is the region to which the La glass belongs. A graph 141 indicates the nd-νd relationship in the case where the volume of Si₃N₄ nano-fine particles contained in a nanocomposite material in which only the Si₃N₄ nano-fine particles are dispersed in a matrix composed of a resin material is varied. A graph 142 indicates the nd-νd relationship in the case where the volume of Al₂O₃ nano-fine particles contained in a nanocomposite material in which only the Al₂O₃ nano-fine particles are dispersed in a matrix composed of a resin material is varied.

In FIG. 14, a hatched region 143 enclosed by the graph 141 and the graph 142 is a region indicating the optical properties that can be obtained when the volume fractions of Si₃N₄ nano-fine particles and Al₂O₃ nano-fine particles are varied in a nanocomposite material in which the Si₃N₄ nano-fine particles and the Al₂O₃ nano-fine particles are dispersed in a matrix composed of a resin material. That is, by appropriately adjusting the volume fractions of the Si₃N₄ nano-fine particles and the Al₂O₃ nano-fine particles, it is possible to obtain a nanocomposite material having the optical properties in the region 143.

Further, as shown in FIG. 14, the region 143 exists also in the region on the upper left side of the line 140, to which the La glass belongs. That is, by appropriately adjusting the volume fractions of the Si₃N₄ nano-fine particles and the Al₂O₃ nano-fine particles, it is possible to obtain a nanocomposite material having the optical properties in the region on the upper left side of the line 140, to which the La glass belongs.

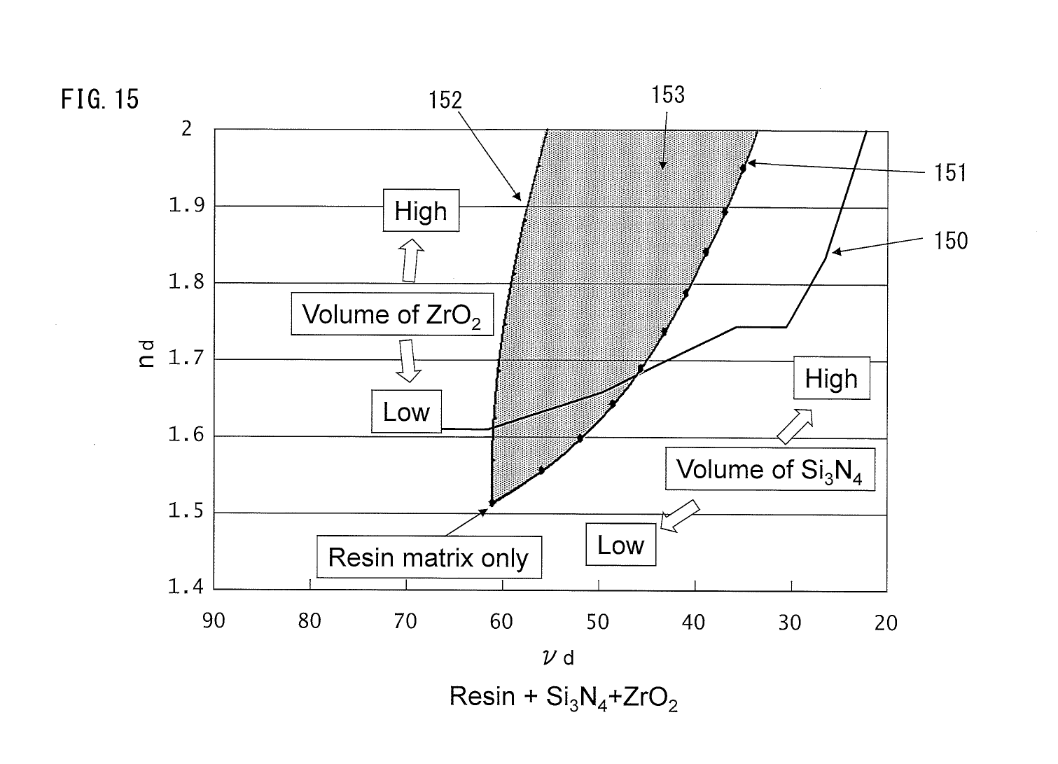

FIG. 15 is a graph showing the nd-νd relationship of a formed nanocomposite material when the volume fractions of Si₃N₄ nano-fine particles and ZrO₂ nano-fine particles are varied.

In FIG. 15, a line 150 indicates a boundary between a region to which a La glass belongs and a region of other glass, and a region on the upper left side of the line 150 is the region to which the La glass belongs. A graph 151 indicates the nd-νd relationship in the case where the volume of Si₃N₄ nano-fine particles contained in a nanocomposite material in which only the Si₃N₄ nano-fine particles are dispersed in a matrix composed of a resin material is varied. A graph 152 indicates the nd-νd relationship in the case where the volume of ZrO₂ nano-fine particles contained in a nanocomposite material in which only the ZrO₂ nano-fine particles are dispersed in a matrix composed of a resin material is varied.

In FIG. 15, a hatched region 153 enclosed by the graph 151 and the graph 152 is a region indicating the optical properties that can be obtained when the volume fractions of Si₃N₄ nano-fine particles and ZrO₂ nano-fine particles are varied in a nanocomposite material in which the Si₃N₄ nano-fine particles and the ZrO₂ nano-fine particles are dispersed in a matrix composed of a resin material. That is, by appropriately adjusting the volume fractions of the Si₃N₄ nano-fine particles and the ZrO₂ nano-fine particles, it is possible to obtain a nanocomposite material having the optical properties in the region 153.

Further, as shown in FIG. 15, the region 153 exists also in the region on the upper left side of the line 150, to which the La glass belongs. That is, by appropriately adjusting the volume fractions of the Si₃N₄ nano-fine particles and the ZrO₂ nano-fine particles, it is possible to obtain a nanocomposite material having the optical properties in the region on the upper left side of the line 150, to which the La glass belongs.

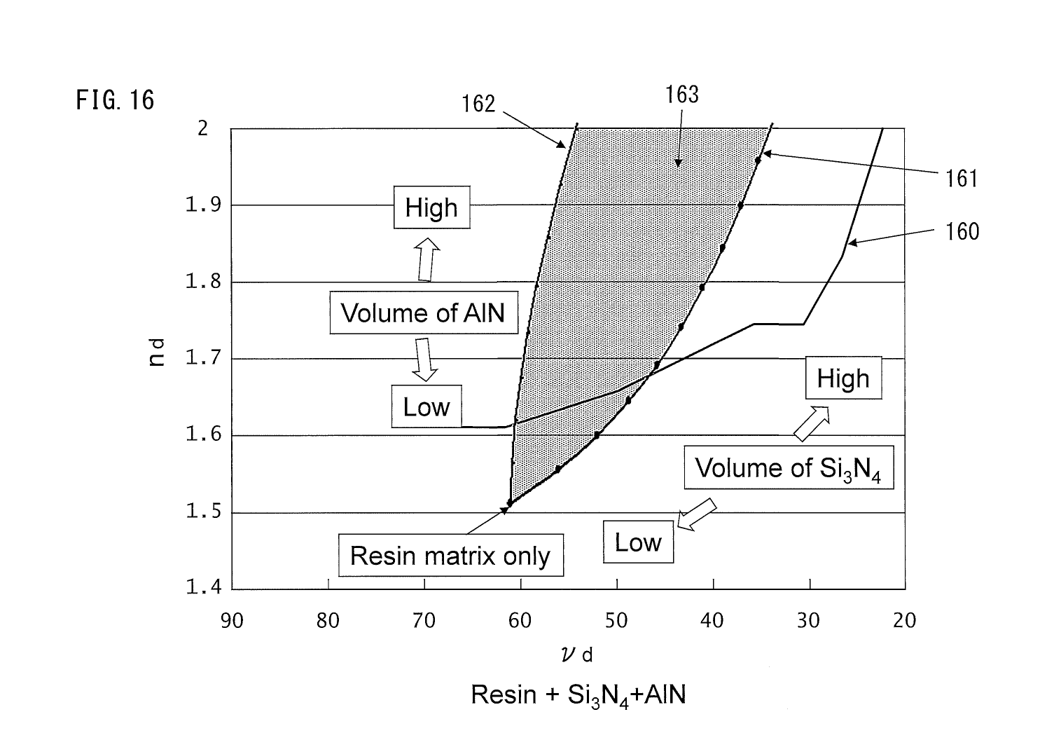

FIG. 16 is a graph showing the nd-νd relationship of a formed nanocomposite material when the volume fractions of Si₃N₄ nano-fine particles and AlN nano-fine particles are varied.

In FIG. 16, a line 160 indicates a boundary between a region to which a La glass belongs and a region of other glass, and a region on the upper left side of the line 160 is the region to which the La glass belongs. A graph 161 indicates the nd-νd relationship in the case where the volume of Si₃N₄ nano-fine particles contained in a nanocomposite material in which only the Si₃N₄ nano-fine particles are dispersed in a matrix composed of a resin material is varied. A graph 162 indicates the nd-νd relationship in the case where the volume of AlN nano-fine particles contained in a nanocomposite material in which only the AlN nano-fine particles are dispersed in a matrix composed of a resin material is varied.

In FIG. 16, a hatched region 163 enclosed by the graph 161 and the graph 162 is a region indicating the optical properties that can be obtained when the volume fractions of Si₃N₄ nano-fine particles and AlN nano-fine particles are varied in a nanocomposite material in which the Si₃N₄ nano-fine particles and the AlN nano-fine particles are dispersed in a matrix composed of a resin material. That is, by appropriately adjusting the volume fractions of the Si₃N₄ nano-fine particles and the MN nano-fine particles, it is possible to obtain a nanocomposite material having the optical properties in the region 163.

Further, as shown in FIG. 16, the region 163 exists also in the region on the upper left side of the line 160, to which the La glass belongs. That is, by appropriately adjusting the volume fractions of the Si₃N₄ nano-fine particles and the AlN nano-fine particles, it is possible to obtain a nanocomposite material having the optical properties in the region on the upper left side of the line 160, to which the La glass belongs.

It is apparent from FIGS. 13 to 16 that, when using the nano-fine particles containing Si₃N₄, an intended nanocomposite material having a high refractive index and a high Abbe number, which is included in the region to which the La glass belongs, can be obtained. Further, it is found that, by adding C, Al₂O₃, ZrO₂ or AlN to Si₃N₄, a nanocomposite material included in a wider region to which the La glass belongs can be obtained.

As described above, in the case where the nano-fine particles containing Si₃N₄ are dispersed in the resin material, for example, the content of the nano-fine particles in the resin material is beneficially 10 vol. % or more, and more beneficially, 12 vol. % or more, thereby obtaining a nanocomposite material having a high refractive index and a high Abbe number. In the case where the nano-fine particles containing Si₃N₄ and at least one of C, Al₂O₃, ZrO₂ and AlN are dispersed in the resin material, it is beneficial to appropriately adjust the ratio between Si₃N₄ and at least one of C, Al₂O₃, ZrO₂ and AlN, in view of the refractive index and the Abbe number of the intended optical glass.

### 3. Effect

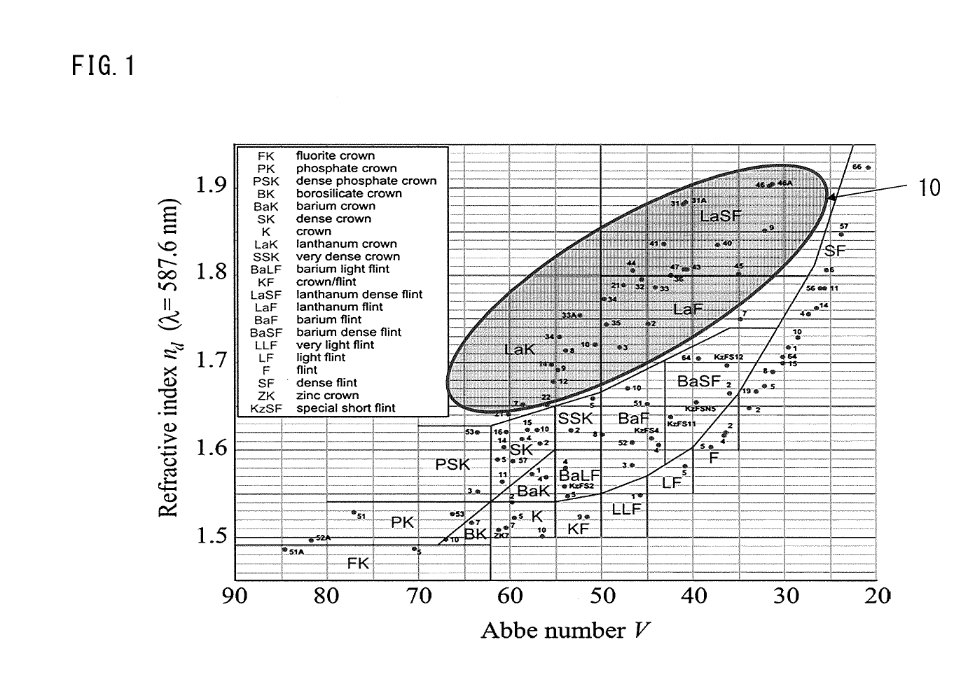

As described above, an optical lens according to the present disclosure is composed of a nanocomposite material containing a resin material, and nano-fine particles dispersed in the resin material, and the nano-fine particles include at least one selected from SiC, ZnS and Si₃N₄. Since the nanocomposite material and the optical lens are each configured as described above, the nanocomposite material is a material having a high refractive index and a high Abbe number, and the optical lens according to the present disclosure is usable as a substitute lens for a lens composed of a La glass such as LaK glass, LaF glass, or LaSF glass in the optical glass classification shown in FIG. 1.

Further, the nano-fine particles may be multiple kinds of nano-fine particles including nano-fine particles formed of at least one selected from SiC, ZnS and Si₃N₄, and nano-fine particles formed of at least one selected from Al₂O₃, ZrO₂, C and AlN, or hybrid nano-fine particles in which at least one selected from Al₂O₃, ZrO₂, C and AlN is added to at least one selected from SiC, ZnS and Si₃N₄, or hybrid nano-fine particles in which at least one selected from SiC, ZnS and Si₃N₄ is added to at least one selected from Al₂O₃, ZrO₂, C and AlN. When the nano-fine particles are such multiple kinds of nano-fine particles or such hybrid nano-fine particles, a resultant nanocomposite material is a material having a high refractive index and a high Abbe number, and the optical lens according to the present disclosure is usable as a substitute lens for a lens composed of a La glass shown in FIG. 1.

The present disclosure is applicable to imaging devices such as DSC. Specifically, the present disclosure is applicable to video movie cameras, camera-equipped cellular phones, camera-equipped smartphones, surveillance cameras, and the like.

As described above, embodiments have been described as examples of art in the present disclosure. Thus, the attached drawings and detailed description have been provided.

Therefore, in order to illustrate the art, not only essential elements for solving the problems but also elements that are not necessary for solving the problems may be included in elements appearing in the attached drawings or in the detailed description. Therefore, such unnecessary elements should not be immediately determined as necessary elements because of their presence in the attached drawings or in the detailed description.

Further, since the embodiments described above are merely examples of the art in the present disclosure, it is understood that various modifications, replacements, additions, omissions, and the like can be performed in the scope of the claims or in an equivalent scope thereof.

What is claimed is:

1. An optical lens comprising a nanocomposite material that includes a resin material, and nano-fine particles dispersed in the resin material, wherein
the nano-fine particles are multiple kinds of nano-fine particles including nano-fine particles formed of at least one selected from SiC, ZnS and Si₃N₄, and nano-fine particles formed of at least one selected from Al₂O₃, ZrO₂, C and AlN.

2. The optical lens as claimed in claim 1, wherein a particle diameter of the nano-fine particles dispersed in the resin material is 100 nm or less.

3. An optical lens comprising a nanocomposite material that includes a resin material, and nano-fine particles dispersed in the resin material, wherein
the nano-fine particles are hybrid nano-fine particles in which at least one selected from Al₂O₃, ZrO₂, C and AlN is added to at least one selected from SiC, ZnS and Si₃N₄.

4. The optical lens as claimed in claim 3, wherein a particle diameter of the nano-fine particles dispersed in the resin material is 100 nm or less.

5. An optical lens comprising a nanocomposite material that includes a resin material, and nano-fine particles dispersed in the resin material, wherein
the nano-fine particles are hybrid nano-fine particles in which at least one selected from SiC, ZnS and Si₃N₄ is added to at least one selected from Al₂O₃, ZrO₂, C and AlN.

6. The optical lens as claimed in claim 5, wherein a particle diameter of the nano-fine particles dispersed in the resin material is 100 nm or less.
